(19) United States
(12) Patent Application Publication
(10) Pub. No.: US 2024/0332695 A1
(43) Pub. Date: Oct. 3, 2024

(54) BATTERY PACK

(71) Applicant: HONDA MOTOR CO., LTD., Tokyo (JP)

(72) Inventors: Yohei AZUMA, Tokyo (JP); Yusuke OKAMOTO, Tokyo (JP)

(73) Assignee: HONDA MOTOR CO., LTD., Tokyo (JP)

(21) Appl. No.: 18/586,586

(22) Filed: Feb. 26, 2024

(30) Foreign Application Priority Data
Mar. 29, 2023 (JP) 2023-053304

(51) Int. Cl. H01M 50/224; H01M 50/209; H01M 50/242; H01M 50/249; H01M 50/30

(52) U.S. Cl. CPC H01M 50/224; H01M 50/242; H01M 50/30; H01M 50/209; H01M 50/249; H01M 2220/20

(57) ABSTRACT

A battery pack that accommodates a plurality of battery modules, the battery pack includes: a lower case that covers lower portions of the plurality of battery modules; and an upper cover that covers upper portions of the plurality of battery modules, wherein the lower case includes: a bottom plate; a front wall; a rear wall; a left wall; and a right wall, the plurality of battery modules are disposed in a battery module accommodating portion, the lower case is provided with a cross member, and a cover frame, the cross member is made of a solid-structured metal and extends in the left-right direction such that a position of an upper end thereof is lowered from both left and right ends toward a left-right direction central portion, and the cover frame is formed of a metal plate member and is fixed to the cross member.

### CROSS-REFERENCE TO RELATED APPLICATIONS

This application is based on and claims priority under 35 USC 119 from Japanese Patent Application No. 2023-053304 filed on Mar. 29, 2023, the entire content of which is incorporated herein by reference.

### TECHNICAL FIELD

The present invention relates to a battery pack mounted on a vehicle or the like.

### BACKGROUND ART

In recent years, researches and developments have been conducted on a secondary battery which contributes to improvement in energy efficiency in order to allow more people to have access to affordable, reliable, sustainable and advanced energy. Especially, with regard to vehicles, due to increasing awareness of global environment protection in recent years, electrification of drive sources such as hybrid vehicles and electric automobiles is rapidly progressing. A battery pack mounted on an electric vehicle includes a battery case that accommodates a battery module (for example, see JP2022-097816A).

In order to ensure strength, the battery case is provided with a cross member extending in a left-right direction. The battery case and the cross member are made of, for example, iron.

### SUMMARY OF INVENTION

For weight reduction, aluminum die-casting is adopted as a material of the battery case and the cross member instead of iron, and to obtain the same strength with aluminum die-casting as with iron, it is necessary to increase a width of the cross member. However, when the width of the cross member is increased, a space in the battery case is consumed, resulting in an increase in an overall length of the battery pack.

The present invention provides a battery pack whose size can be reduced while ensuring strength. This further contributes to improvement in energy efficiency.

According to the present invention, a load at the time of collision can be received by both the cross member made of the solid-structured metal and the cover frame formed of the metal plate member, which are provided at the lower case. Accordingly, since a width of the cross member in the front-rear direction can be reduced, a space required for the cross member in the battery pack can be reduced, and a size of the battery pack can be reduced.

### BRIEF DESCRIPTION OF DRAWINGS

FIG. 1 is a perspective view of a battery pack according to an embodiment of the present invention.

FIG. 2 is a perspective view of the battery pack in FIG. 1 in a state in which an upper cover is removed.

FIG. 3 is a perspective view of a lower case of the battery pack in FIG. 1.

FIG. 4 is a main-part-enlarged cross-sectional view of a cross member and a cover frame of the battery pack in FIG. 1.

FIG. 5 is a perspective view showing a flow of high-temperature gas generated by a battery module in the battery pack in FIG. 1.

FIG. 6 is an enlarged view of a pressure release valve and a temperature sensor of the battery pack in FIG. 1.

FIG. 7 is a main-part-enlarged cross-sectional view (reference drawing) showing a flow of high-temperature gas generated by the battery module when an upper end of the cover frame extends in a left-right direction at a height lower than an upper end of the battery module in the battery pack in FIG. 1.

FIG. 8 is a perspective view (reference drawing) showing a flow of high-temperature gas generated by the battery module when the upper end of the cover frame extends in the left-right direction at a height lower than the upper end of the battery module in the battery pack in FIG. 1.

### DESCRIPTION OF EMBODIMENTS

Hereinafter, an embodiment of a battery pack of the present invention will be described with reference to the accompanying drawings. The drawings are viewed in directions of reference numerals.

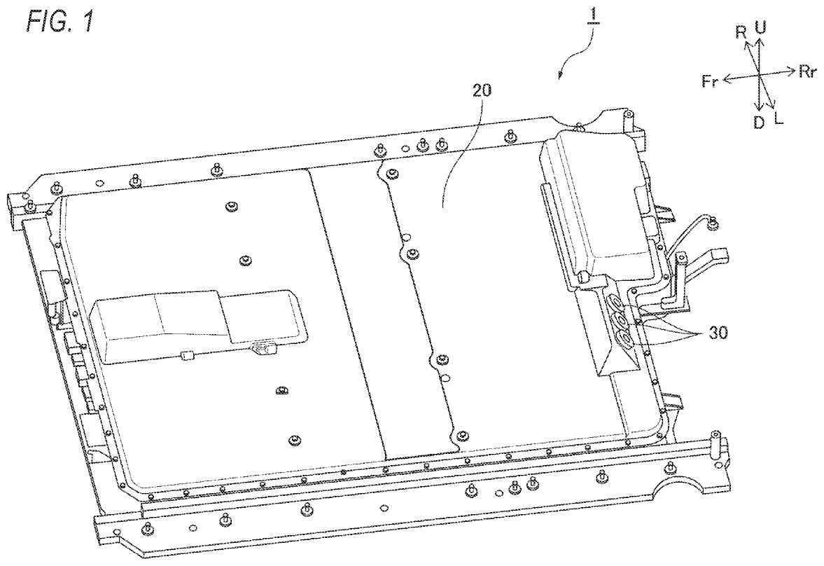

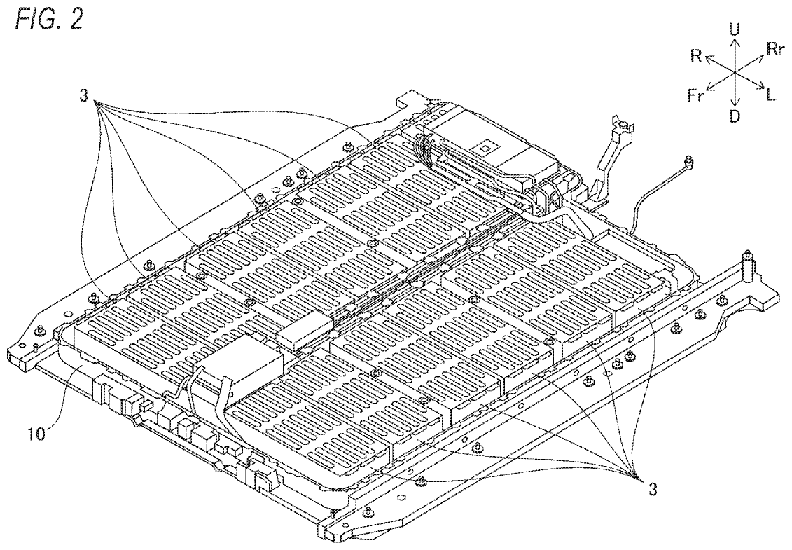

As shown in FIGS. 1 and 2, a battery pack 1 according to the embodiment of the present invention is a flat plate-like member having a rectangular shape in a plan view and having a predetermined thickness. The battery pack 1 is mounted on a floor or the like of an electric vehicle in order to drive a drive source driven by electric power. The drive source driven by electric power is, for example, a vehicle drive motor.

The battery pack 1 accommodates a plurality of battery modules 3 in which a plurality of battery cells are stacked. The battery pack 1 includes a lower case 10 that covers lower portions of the plurality of battery modules 3, and an upper cover 20 that covers upper portions of the plurality of battery modules 3.

In the present specification and the like, in order to simplify and clarify the description, for convenience, a direction in which a surface where a pressure release valve 30 to be described later is provided faces is defined as a front-rear direction, and an upper-lower direction and a left-right direction are described according to directions viewed from the battery pack 1. In the drawings, a front side of the battery pack 1 is denoted by Fr, a rear side is denoted by Rr, a left side is denoted by L, a right side is denoted by R, an upper side is denoted by U, and a lower side is denoted by D. The upper-lower direction, the front-rear direction, and the left-right direction described in the present specification and the like are not related to directions of a product where the battery pack 1 is mounted. That is, when the battery pack 1 is mounted on a vehicle, the upper-lower direction, the front-rear direction, and the left-right direction denoted in this specification and the like may or may not coincide with an upper-lower direction, a front-rear direction, and a left-right direction viewed from the vehicle.

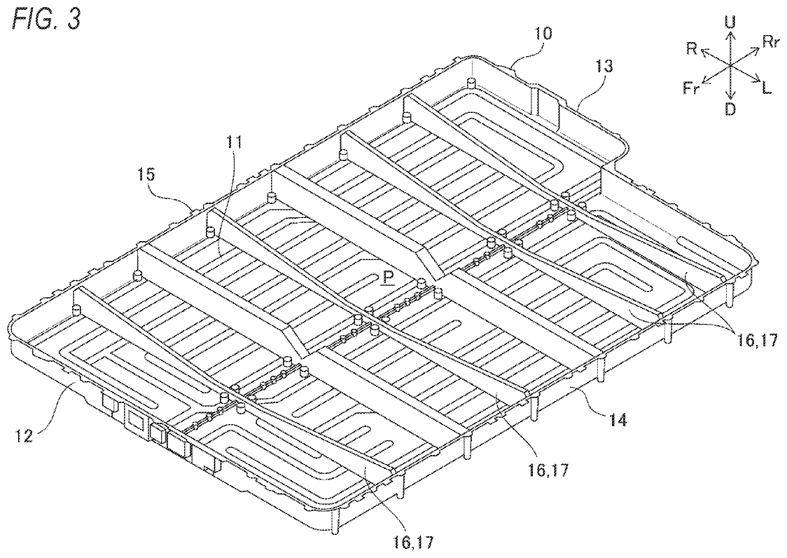

As shown in FIG. 3, the lower case 10 includes a bottom plate 11, a front wall 12, a rear wall 13, a left wall 14, and a right wall 15. The bottom plate 11 is a flat plate-like portion corresponding to a bottom portion of the lower case 10 and covers the lower portions of the plurality of battery modules 3. The front wall 12 is a wall-like portion that stands upward and extends in the left-right direction at a front portion of the bottom plate 11. The rear wall 13 is a wall-like portion that stands upward and extends in the left-right direction at a rear portion of the bottom plate 11. The left wall 14 is a wall-like portion that stands upward and extends in the front-rear direction at a left portion of the bottom plate 11. The right wall 15 is a wall-like portion that stands upward and extends in the front-rear direction at a right portion of the bottom plate 11.

A battery module accommodating portion P is defined by a space surrounded by the bottom plate 11, the front wall 12, the rear wall 13, the left wall 14, and the right wall 15. The plurality of battery modules 3 are disposed in the battery module accommodating portion P. In the present embodiment, the battery modules 3 are aligned in the front-rear direction in two rows in the left-right direction in the battery module accommodating portion P, and seven battery modules 3 are aligned in a right row whereas six battery modules 3 are aligned in a left row in the front-rear direction.

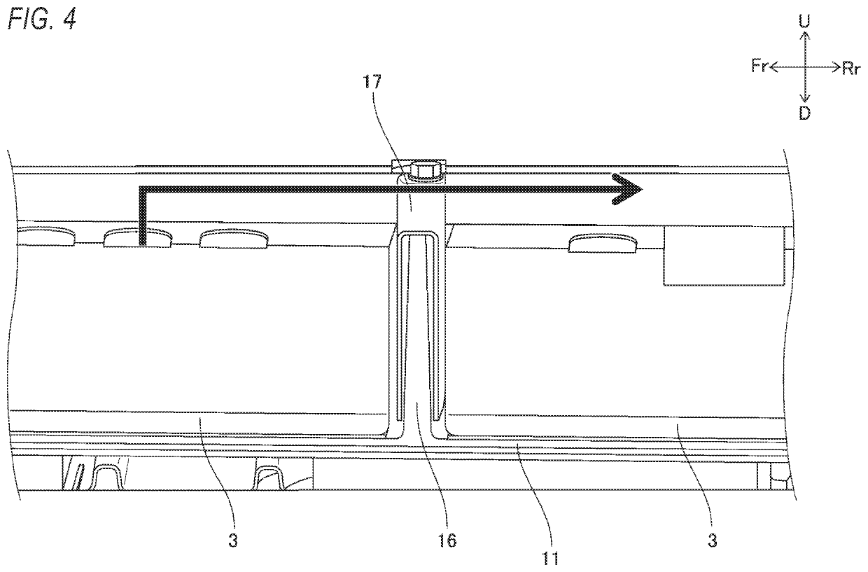

As shown in FIG. 3, the lower case 10 includes a cross member 16 that stands upward from the bottom plate 11 in the battery module accommodating portion P and extends in the left-right direction continuously from the left wall 14 to the right wall 15. Further, the lower case 10 is provided with a cover frame 17 (see FIG. 4) that covers at least a part of an upper portion of the cross member 16 and extends in the left-right direction.

The cross member 16 is made of a solid-structured metal and extends in the left-right direction such that a position of an upper end thereof lowers from both left and right ends toward a left-right direction central portion. In the present embodiment, the cross member 16 has substantially the same height as the left wall 14 and the right wall 15 at a portion in contact with the left wall 14 and the right wall 15, and the height linearly decreases from each of the left wall 14 and the right wall 15 toward the left-right direction central portion.

The cover frame 17 is formed of a metal plate member and is fixed to the cross member 16. In the present embodiment, the cover frame 17 has a substantially C-shaped cross-section when viewed in the left-right direction, and covers the upper end and a side surface of the cross member 16.

According to the battery pack 1 according to the present embodiment, a load at the time of collision can be received by both the cross member 16 made of the solid-structured metal and the cover frame 17 formed of the metal plate member, which are provided at the lower case 10. Accordingly, since a width of the cross member 16 in the front-rear direction can be reduced, a space required for the cross member 16 in the battery pack 1 can be reduced, and a size of the battery pack 1 can be reduced.

Further, since the load at the time of collision is received by both the cross member 16 and the cover frame 17, the load applied to the cross member 16 at the time of collision can be reduced, and thus the height of the central area of the cross member 16 can be reduced. Accordingly, a weight of the solid-structured cross member 16 can be reduced, and a weight of the battery pack 1 can be reduced.

The bottom plate 11, the front wall 12, the rear wall 13, the left wall 14, the right wall 15, the cross member 16, and the cover frame 17 may be made of any metal material. In the present embodiment, the bottom plate 11, the front wall 12, the rear wall 13, the left wall 14, the right wall 15, and the cross member 16 are integrally formed of aluminum, and the cover frame 17 is made of iron.

Since the bottom plate 11, the front wall 12, the rear wall 13, the left wall 14, the right wall 15, and the cross member 16 are integrally formed of aluminum, the load at the time of collision can be distributed to the cross member 16 and the lower case 10. Further, since the cover frame 17 is made of iron, heat resistance is improved, and the load applied to the cover frame 17 together with the cross member 16 and the lower case 10 at the time of collision is easily adjusted.

In the battery module accommodating portion P, the plurality of battery modules 3 are aligned at least in the front-rear direction. The cross member 16 extends in the left-right direction between the battery modules 3 aligned in the front-rear direction, and the cover frame 17 also extends in the left-right direction between the battery modules 3 aligned in the front-rear direction.

As shown in FIG. 4, regarding a relationship between the cover frame 17 and the battery module 3, an upper end of the cover frame 17 may extend in the left-right direction at a height equal to or higher than an upper end of the battery module 3. In this case, the height of the cross member 16 may be substantially the same across the left wall 14 and the right wall 15 and may not decrease from each of the left wall 14 and the right wall 15 toward the left-right direction central portion.

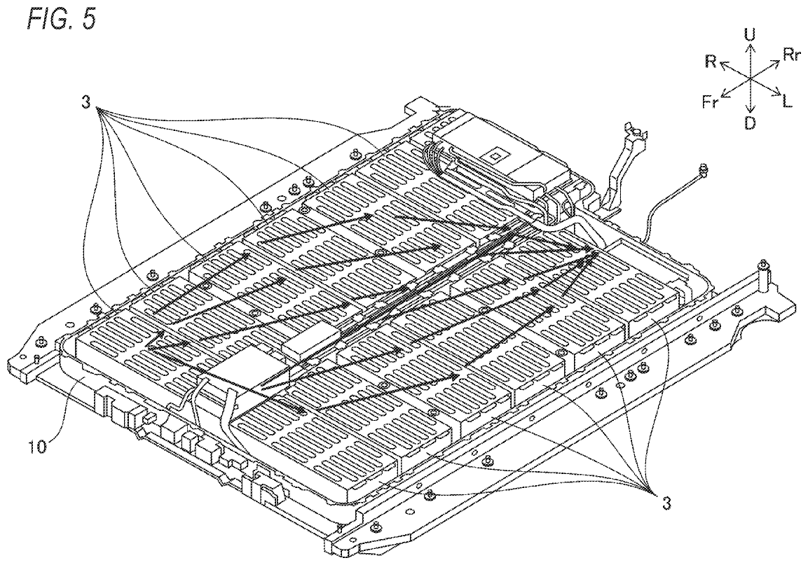

Since the upper end of the cover frame 17 extends in the left-right direction at a height equal to or higher than the upper end of the battery module 3, when high-temperature gas is generated by the battery module 3, the high-temperature gas is prevented from flowing into a space between the battery modules 3 aligned in the front-rear direction as indicated by an arrow in FIG. 4, and easily flows above the battery modules 3. As indicated by arrows in FIG. 5, the high-temperature gas generated by each battery module 3 flows rearward above the battery modules 3 toward the pressure release valve 30.

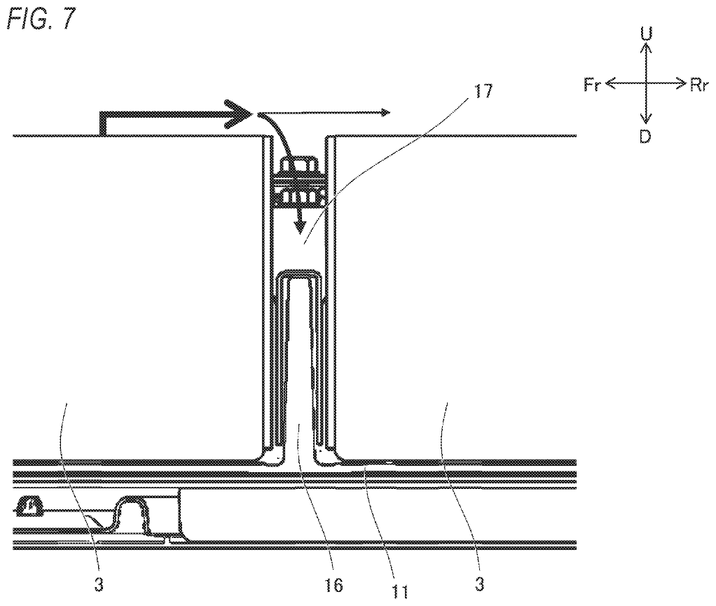

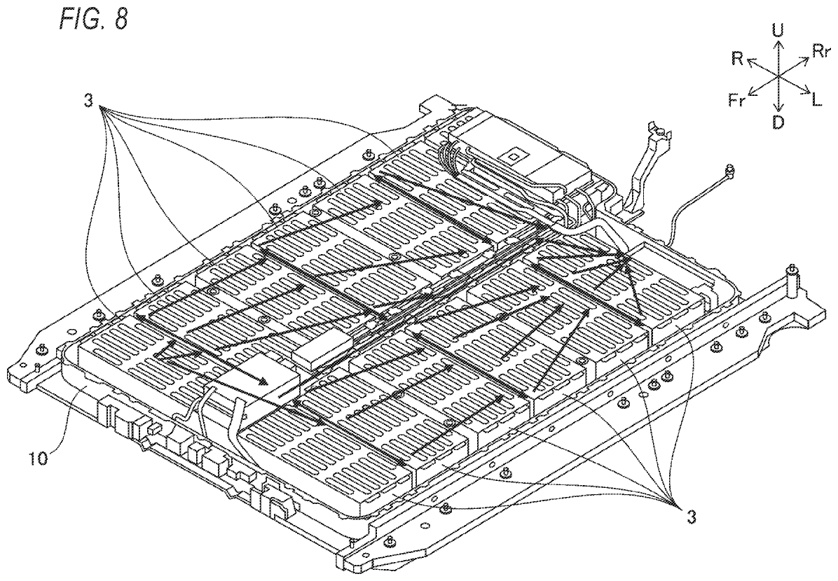

In contrast, in a case where the upper end of the cover frame 17 extends in the left-right direction at a height lower than the upper end of each battery module 3 as shown in FIGS. 7 and 8, when high-temperature gas is generated by the battery module 3, a part of the high-temperature gas generated by the battery module 3 flows to an upper portion of the cover frame 17, that is, the space between the battery modules 3 aligned in the front-rear direction, as shown by an arrow in FIG. 7. As indicated by arrows in FIG. 8, the high-temperature gas generated by each battery module 3 not only flows rearward above the battery modules 3 toward the pressure release valve 30, but also partially flows between the battery modules 3 aligned in the front-rear direction and flows in the left-right direction between the battery modules 3 aligned in the front-rear direction. Therefore, the high-temperature gas comes into contact with a front surface and a rear surface of each battery module 3, the battery module 3 receives heat of the high-temperature gas and a temperature thereof is increased. When the temperature of the battery modules 3 is increased, thermal chaining is likely to occur between the battery modules 3.

In the present embodiment, the upper end of the cover frame 17 extends in the left-right direction at a height equal to or higher than the upper end of the battery module 3. Accordingly, when high-temperature gas is generated by each battery module 3, the high-temperature gas can be prevented from flowing into the space between the battery modules 3 aligned in the front-rear direction, thus the battery modules 3 can be prevented from receiving heat from the high-temperature gas and increasing a temperature thereof, and thermal chaining between the battery modules 3 can be prevented.

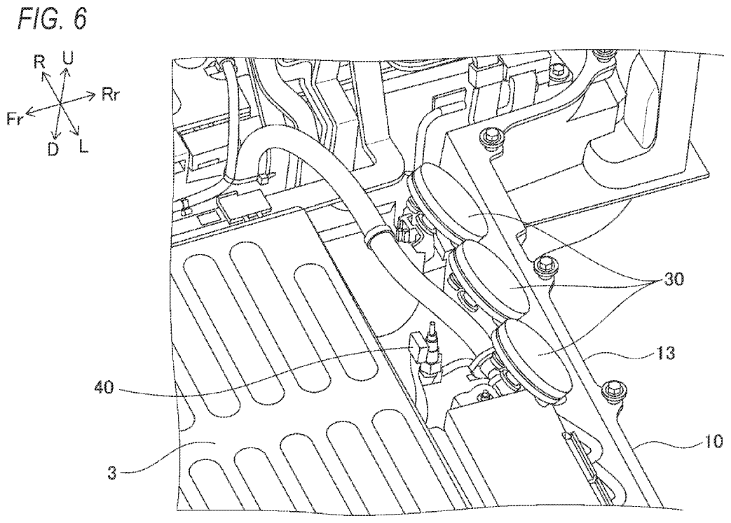

As shown in FIGS. 1 and 6, the battery pack 1 includes one or a plurality of pressure release valves 30 that enable gas to be discharged to the outside of the battery pack 1 from an internal space (substantially equal to the battery module accommodating portion P) of the battery pack 1 surrounded by the lower case 10 and the upper cover 20. As shown in FIG. 6, the battery pack 1 includes a temperature sensor 40 that is provided in the internal space of the battery pack 1 to detect a temperature of the internal space of the battery pack 1.

The pressure release valve 30 is concentrated at a front portion or a rear portion of the battery pack 1, and the temperature sensor 40 is disposed in the vicinity of the pressure release valve 30. In the present embodiment, the pressure release valve 30 and the temperature sensor 40 are concentrated at the rear portion of the battery pack 1, and alternatively, may be integrated at the front portion.

Since the pressure release valve 30 is concentrated at the front portion or the rear portion of the battery pack 1, a flow of gas when the high-temperature gas generated by each battery module 3 flows above the battery modules 3 toward the pressure release valve 30 is simplified, and thus the high-temperature gas is prevented from circulating between the battery modules 3. Further, in addition to simplifying the flow of the gas flow when flowing above the battery modules 3, the temperature of the internal space of the battery pack 1 can be detected more accurately by disposing the temperature sensor 40 in the vicinity of the pressure release valve 30.

Although an embodiment of the present invention has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, respective constituent elements in the above embodiments may be freely combined without departing from the gist of the invention.

In the present specification, at least the following matters are described. In the parentheses, the corresponding constituent elements and the like in the above embodiment are shown as an example, but the present invention is not limited thereto.
(1) A battery pack (battery pack 1) that accommodates a plurality of battery modules (battery module 3) in which a plurality of battery cells are stacked, the battery pack including:
a lower case (lower case 10) that covers lower portions of the plurality of battery modules; and
an upper cover (upper cover 20) that covers upper portions of the plurality of battery modules, in which
the lower case includes:
   a bottom plate (bottom plate 11) that covers the lower portions of the plurality of battery modules;
   a front wall (front wall 12) that stands upward and extends in a left-right direction at a front portion of the bottom plate;
   a rear wall (rear wall 13) that stands upward and extends in the left-right direction at a rear portion of the bottom plate;
   a left wall (left wall 14) that stands upward and extends in a front-rear direction at a left portion of the bottom plate; and
   a right wall (right wall 15) that stands upward and extends in the front-rear direction at a right portion of the bottom plate,
the plurality of battery modules are disposed in a battery module accommodating portion (battery module accommodating portion P) surrounded by the bottom plate, the front wall, the rear wall, the left wall, and the right wall,
the lower case is provided with
   a cross member (cross member 16) that stands upward from the bottom plate and extends in the left-right direction continuously from the left wall to the right wall in the battery module accommodating portion, and
   a cover frame (cover frame 17) that covers at least a part of an upper portion of the cross member and extends in the left-right direction,
the cross member is made of a solid-structured metal and extends in the left-right direction such that a position of an upper end thereof is lowered from both left and right ends toward a left-right direction central portion, and
the cover frame is formed of a metal plate member and is fixed to the cross member.

According to (1), a load at the time of collision can be received by both the cross member made of the solid-structured metal and the cover frame formed of the metal plate member, which are provided at the lower case. Accordingly, since a width of the cross member in the front-rear direction can be reduced, a space required for the cross member in the battery pack can be reduced, and a size of the battery pack can be reduced. Further, since the load at the time of collision is received by both the cross member and the cover frame, the load applied to the cross member at the time of collision can be reduced, and thus the height of the central area of the cross member can be reduced. Accordingly, a weight of the solid-structured cross member can be reduced, and a weight of the battery pack can be reduced.
(2) The battery pack according to (1), in which
the bottom plate, the front wall, the rear wall, the left wall, the right wall, and the cross member are integrally formed of aluminum, and
the cover frame is made of iron.

According to (2), since the bottom plate, the front wall, the rear wall, the left wall, the right wall, and the cross member are integrally formed of aluminum, the load at the time of collision can be distributed to the cross member and the lower case. Further, since the cover frame is made of iron, heat resistance is improved, and the load applied to the cover frame together with the cross member and the lower case at the time of collision is easily adjusted.
(3) The battery pack according to (1) or (2), in which
the plurality of battery modules are aligned in the front-rear direction in the battery module accommodating portion,
the cross member extends in the left-right direction between the battery modules aligned in the front-rear direction,
the cover frame extends in the left-right direction between the battery modules aligned in the front-rear direction, and
an upper end of the cover frame extends in the left-right direction at a height equal to or higher than an upper end of each battery module.

According to (3), since the upper end of the cover frame extends in the left-right direction at a height equal to or higher than the upper end of the battery module, high-temperature gas generated by the battery module is prevented from flowing between the battery modules aligned in the front-rear direction, and easily flows above the battery modules. Accordingly, the battery modules can be prevented from receiving heat of the high-temperature gas and increasing a temperature thereof, and thus thermal chaining between the battery modules can be prevented.
(4) The battery pack according to (3), further including:
one or a plurality of pressure release valves (pressure release valve 30) that enable gas to be discharged to outside of the battery pack from a battery pack internal space surrounded by the lower case and the upper cover; and
a temperature sensor (temperature sensor 40) that is provided in the battery pack internal space and configured to detect a temperature in the battery pack internal space, in which
the pressure release valve is concentrated at a front portion or a rear portion of the battery pack, and
the temperature sensor is disposed in the vicinity of the pressure release valve.

According to (4), since the pressure release valve is concentrated at the front portion or the rear portion of the battery pack, a flow of gas when the high-temperature gas generated by each battery module flows above the battery modules toward the pressure release valve is simplified, and thus the high-temperature gas is prevented from circulating between the battery modules. Further, in addition to simplifying the flow of the gas flow when flowing above the battery modules, the temperature of the battery pack internal space can be detected more accurately by disposing the temperature sensor in the vicinity of the pressure release valve.

What is claimed is:

1. A battery pack that accommodates a plurality of battery modules in which a plurality of battery cells are stacked, the battery pack comprising:
a lower case that covers lower portions of the plurality of battery modules; and
an upper cover that covers upper portions of the plurality of battery modules, wherein
the lower case includes:
a bottom plate that covers the lower portions of the plurality of battery modules;
a front wall that stands upward and extends in a left-right direction at a front portion of the bottom plate;
a rear wall that stands upward and extends in the left-right direction at a rear portion of the bottom plate;
a left wall that stands upward and extends in a front-rear direction at a left portion of the bottom plate; and
a right wall that stands upward and extends in the front-rear direction at a right portion of the bottom plate,
the plurality of battery modules are disposed in a battery module accommodating portion surrounded by the bottom plate, the front wall, the rear wall, the left wall, and the right wall,
the lower case is provided with
a cross member that stands upward from the bottom plate and extends in the left-right direction continuously from the left wall to the right wall in the battery module accommodating portion, and
a cover frame that covers at least a part of an upper portion of the cross member and extends in the left-right direction,
the cross member is made of a solid-structured metal and extends in the left-right direction such that a position of an upper end thereof is lowered from both left and right ends toward a left-right direction central portion, and
the cover frame is formed of a metal plate member and is fixed to the cross member.

2. The battery pack according to claim 1, wherein
the bottom plate, the front wall, the rear wall, the left wall, the right wall, and the cross member are integrally formed of aluminum, and
the cover frame is made of iron.

3. The battery pack according to claim 1, wherein
the plurality of battery modules are aligned in the front-rear direction in the battery module accommodating portion,
the cross member extends in the left-right direction between the battery modules aligned in the front-rear direction,
the cover frame extends in the left-right direction between the battery modules aligned in the front-rear direction, and
an upper end of the cover frame extends in the left-right direction at a height equal to or higher than an upper end of each battery module.

4. The battery pack according to claim 3, further comprising:
one or a plurality of pressure release valves that enable gas to be discharged to outside of the battery pack from a battery pack internal space surrounded by the lower case and the upper cover; and
a temperature sensor that is provided in the battery pack internal space and configured to detect a temperature in the battery pack internal space, wherein
the pressure release valve is concentrated at a front portion or a rear portion of the battery pack, and
the temperature sensor is disposed in the vicinity of the pressure release valve.
